(19) United States
(12) Patent Application Publication
(10) Pub. No.: US 2018/0107197 A1
(43) Pub. Date: Apr. 19, 2018

(54) INFORMATION PROCESSING DEVICE

(71) Applicant: FANUC CORPORATION, Minamitsuru-gun (JP)

(72) Inventors: Kenji Tanaka, Minamitsuru-gun (JP); Makoto Haga, Minamitsuru-gun (JP)

(73) Assignee: FANUC CORPORATION, Minamitsuru-gun (JP)

(21) Appl. No.: 15/783,033

(22) Filed: Oct. 13, 2017

(30) Foreign Application Priority Data
Oct. 14, 2016 (JP) 2016-202743

(51) Int. Cl. G05B 19/418; G05B 19/4097

(52) U.S. Cl. CPC G05B 19/4187; G05B 2219/31325; G05B 19/4097; G05B 19/4183

(57) ABSTRACT

An information processing device includes: for each of a plurality of machine tools, a machine information database configured to store machine configuration information and tool information of each of the plurality of machine tools, in association with each of the plurality of machine tools; an information collection unit configured to collect and store the machine configuration information and the tool information into the machine information database; a manufacturing planning work information input unit configured to receive manufacturing planning work information; a machine information collation unit configured to collate the manufacturing planning work information with the machine configuration information and the tool information to give a score to each of the plurality of machine tools, based on a result of the collation; and an optimum machine selection unit configured to select an optimum machine tool for machining, based on the score given to each of the plurality of machine tools.

### BACKGROUND OF THE INVENTION

### 1. Field of the Invention

The present invention relates to an information processing device, and particularly relates to an information processing device that selects an optimum machine for machining.

### 2. Description of the Related Art

In newly machining work to manufacture a product in a factory in which a plurality of machine tools has been installed, there is a need to select a machine tool appropriate to machining of manufacturing the product. In this case, an operator matches information according to the machining of the work in, for example, machining shape, material, size, and mass, with information on, for example, the machine configuration and performance of each machine tool and available tools, so as to select the machine tool appropriate to the machining of manufacturing the product. However, an optimum machine tool may not be selected depending on the proficiency of the operator.

As a conventional technique according to the selection of a machine tool appropriate to machining of a product, for example, JP 60-039049 A discloses a system that previously registers, into a database, layout data, such as shape information on a workpiece, and machine information and tool information necessary for the machining, and provides information on, for example, a machine and a tool necessary for the machining, with specification of a machining shape. WO 02/003156 A discloses a system that connects a plurality of NC machine tools to a central control device through a network and makes a database of machining achievements collected from each NC machine tool so as to perform management so that the information on the database can be used for a maintenance service, a sales strategy, or an estimate of labor costs, for example. Furthermore, JP H10-143231 A discloses a system that connects a numerical controller having a browser function, a DNC function, a POP function, with a machining information computer through a network so that information necessary for machining can be easily taken in through a browser screen of the numerical controller. In the system of JP H10-143231 A, the state of a different numerical controller connected to the machining information computer can be confirmed.

However, the technique disclosed in JP 60-039049 A requires the information necessary for the machining, to be previously registered into the database, and thus has a problem of making registration work time-consuming. The database is required to be updated in accordance with a manufacturing facility arranged in practice, and thus the update is made to be time-consuming. Furthermore, the registration work and the descriptions to be registered into the database require an expert to deal therewith, and thus are difficult for a general operator to deal with.

WO 02/003156 A describes the technique of acquiring the machining achievements from each machine tool connected to the network to make the database, but does not refer to a method of utilizing the information on the machining achievements that have been acquired.

JP H10-143231 A describes, as a feature, that each machine tool performs the machining registered in the machining information computer. However, machining information on a result of the machining performed in practice is not reflected on the machining information included in the machining information computer, and thus may not be utilized for the next machining.

### SUMMARY OF THE INVENTION

Therefore, an object of the present invention is to provide an information processing device that collects machine configuration information (e.g., lathe or machining center, a machining range, and maximum machining work) and tool information (the types of tools and the sizes of the tools) from a manufacturing facility through a communication device and then selects an optimum machine tool for machining from the pieces of information that have been collected.

According to the present invention, machine tools and the information processing device, such as a host computer, are connected through a network. The information processing device collects, from each machine tool, the machine configuration information and the tool information of each machine tool and then makes a registration into a database. The information processing device collates the machine configuration information and manufacturing planning work information so as to select the optimum machine tool so that the problem is solved.

The machine configuration information referred to here, includes information indicating the characteristics of each machine tool, such as the lathe or machining center, the machining range, the maximum machining work (size and mass), and a machining direction. A machine information input screen and a machine information storage area, for registering the machine configuration information indicating the configuration of each machine tool, are prepared for each machine tool so that, for example, a maker of each machine tool or an operator who has set each machine tool, can timely register and update the machine configuration information.

The tool information includes information on the tools registered in each machine tool, and includes information on the tools available in each machine tool. The tool information optionally included in each machine tool is used.

In a state where the machine configuration information and the tool information of each machine tool have been registered in the database, when the operator inputs the manufacturing planning work information (e.g., drawings, size, mass, and material) into the information processing device, the information processing device collates the manufacturing planning work information with the machine configuration information and the tool information of each machine tool registered in the database, so as to select the optimum machine tool and tool for the machining. At this time, in a case where the number of the corresponding machine tools is at least two, the plurality of machine tools may be provided as candidates.

The operator performs the machining with the machine tool and the tool that have been selected, and inputs a determination for a result of the machining, into the machine tool. Then, the information processing device collects, as machining achievement information, determination information to the result input by the operator, together with information, such as a work type, a work shape, a finished shape, a tool type, a jig type, required accuracy, and surface roughness, and makes a registration into the database in association with the machine tool and the manufacturing planning work information. The information processing device also considers a machining achievement registered in the database when selecting a machine tool, so as to be able to select a machine tool and a tool more appropriate to the same machining after that.

An information processing device according to one aspect of the present invention, selects an optimum machine tool for machining from a plurality of machine tools, and includes: a machine information database configured to store, for each of the plurality of machine tools, machine configuration information indicating a machine configuration of each of the plurality of machine tools and tool information including information according to a tool included in each of the plurality of machine tools, in association with each of the plurality of machine tools; an information collection unit configured to collect the machine configuration information and the tool information from each of the plurality of machine tools so as to store the machine information and the tool information into the machine information database; a manufacturing planning work information input unit configured to receive manufacturing planning work information specifying information according to the machining; a machine information collation unit configured to collate the manufacturing planning work information received by the manufacturing planning work information input unit with the machine configuration information and the tool information stored in the machine information database so as to give a score to each of the plurality of machine tools associated with the machine configuration information and the tool information, based on a result of the collation; and an optimum machine selection unit configured to select the optimum machine tool for the machining specified with the manufacturing planning work information, based on the score given to each of the plurality of machine tools by the machine information collation unit.

The machine information database according to the information processing device of the one aspect of the present invention further stores, for each of the plurality of machine tools, drawing information including information according to a description of the machining performed by each of the plurality of machine tools and machining achievement information including information according to an evaluation of a result of the machining, in association with each of the plurality of machine tools, and the machine information collation unit collates the manufacturing planning work information received by the manufacturing planning work information input unit with the drawing information and the machining achievement information stored in the machine information database, so as to perform score-addition to the score, based on a result of the collation.

According to the present invention, the information processing device automatically acquires necessary information from the machine tools to update the database. Thus, an administrator of the information processing device does not need to update the database step by step, and additionally, unnecessary data is not accumulated so that the database waste is eliminated. According to the present invention, the machine tools connected to the information processing device are to be objects so that no attention is required to be paid to a machine tool that has been discarded or replaced. Furthermore, according to the present invention, since a machining achievement is accumulated every time the machining is finished, the information processing device analyzes the machining achievement information and utilizes the analysis for the next selection so that selection accuracy of the machine tool and the tool appropriate to the machining, improves as the machining is repeated, regardless of the proficiency of the operator.

### BRIEF DESCRIPTION OF THE DRAWINGS

The object, a different object, and features of the present invention will be obvious with the descriptions according to an embodiment below with reference to the attached drawings. The drawings are as follows:

FIG. 1 is a diagram of an entire overview according to an embodiment of the present invention;

FIG. 2 is a flowchart of an operation of collecting machine configuration information and tool information according to the embodiment of the present invention;

FIG. 3 is a flowchart of an operation of selecting an optimum machine tool according to the embodiment of the present invention;

FIG. 4 is a flowchart of an operation of collecting drawing information and machining achievement information according to the embodiment of the present invention;

FIG. 5 is a flowchart of an operation of giving a score to machine tools according to the embodiment of the present invention;

FIG. 6 is a schematic functional block diagram of an information processing device and the machine tools according to the embodiment of the present invention;

FIG. 7 is a table of exemplary manufacturing planning work information according to the embodiment of the present invention;

FIG. 8 illustrates tables of exemplary machine configuration information and tool information according to the embodiment of the present invention; and

FIG. 9 illustrates tables of exemplary drawing information and machining achievement information according to the embodiment of the present invention.

### DETAILED DESCRIPTION OF THE PREFERRED EMBODIMENTS

An embodiment of the present invention will be described below with the drawings.

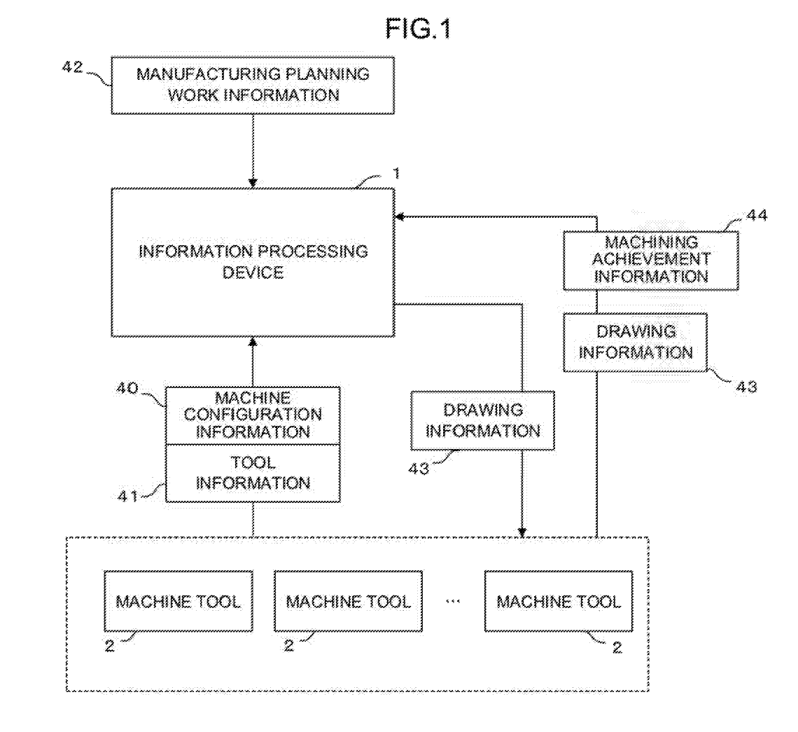

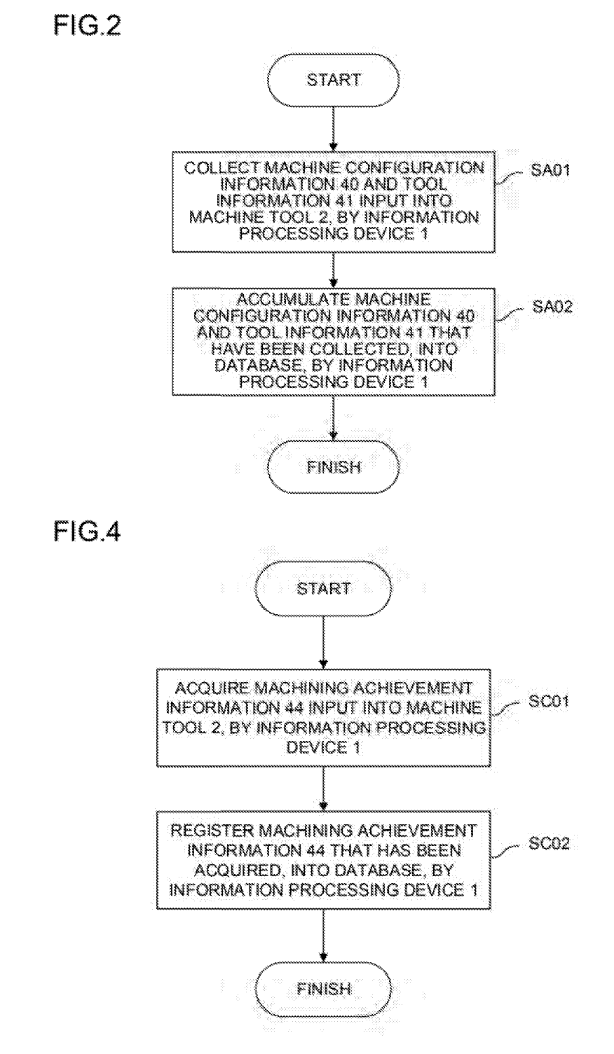

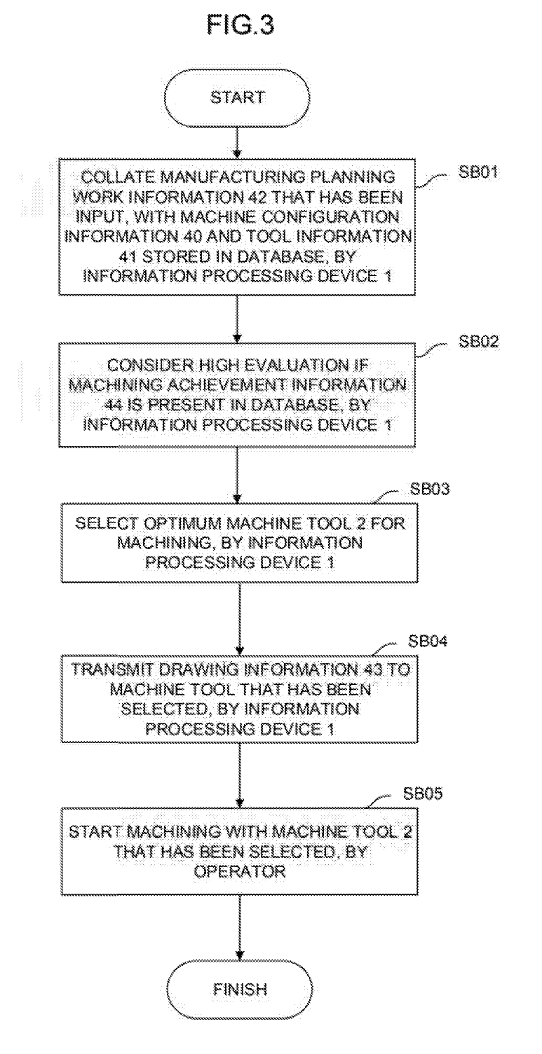

FIG. 1 is a diagram of a schematic entire system connected with an information processing device according to the embodiment of the present invention. The flow of machine tool selection using the information processing device according to the present embodiment will be described below with FIG. 1 and the flowcharts of FIGS. 2 to 5.

The information processing device 1 according to the present embodiment is connected with a plurality of machine tools 2 through a wired/wireless communication line. The information processing device 1 includes a database inside or outside, and information collected from each machine tool 2 is stored and managed in the database.

Each machine tool 2 used for machining work, may include, for example, a numerical controller and a machine controlled by the numerical controller. In that case, the unit of the numerical controller performs an exchange with the information processing device 1, input reception of machine configuration information, tool information, and machining achievement information from an operator, and storage management.

Each machine tool 2 includes the machine configuration information (e.g., lathe or machining center, a machining range, and maximum machining work mass) indicating the configuration of each machine tool 2, that has been previously input through a machine information input screen, stored in a machine information storage area of each machine tool 2. A maker of each machine tool 2 may make the input before shipment of each machine tool 2, a maintenance worker of the maker may make the input when performing maintenance work after installation is performed in a factory, or an operator in the factory may make the input when using each machine tool 2.

The machine configuration information may be appropriately changed, for example, in a case where the configuration of each machine tool 2 varies. The input of the machine configuration information as described above is timely made during operation of each machine tool 2, and thus the input is not made as a purpose of only operation of the information processing device 1 according to the embodiment of the present invention.

Note that, in a case where each machine tool 2 has a function of managing the tool information, the tool information is also input so as to be stored in the machine information storage area.

The information processing device 1 acquires the machine configuration information 40 and the tool information 41 stored in the machine information storage area of each of the plurality of machine tools 2, through the communication line (step SA01), and performs accumulation into the database (step SA02).

The operator inputs manufacturing planning work information 42 (e.g., drawings, size, mass, and material) into the information processing device 1. When the manufacturing planning work information 42 is input, the information processing device 1 collates the manufacturing planning work information 42 that has been input, with the pieces of machine configuration information 40 and the pieces of tool information 41 registered in the database (step SB01), and selects a machine tool 2 appropriate to the machining on the basis of a result of the collation. At this time, if, for the same work, machining achievement information 44 is present in the database, the machining achievement information 44 is taken in consideration (step SB02), and then a machine tool 2 having an higher evaluation is selected (step SB03).

In the collation of the manufacturing planning work information 42 with the pieces of machine configuration information 40 and the pieces of tool information 41 registered in the database, by the information processing device 1, for example, the machining range of the machine tool 2 included in a piece of machine configuration information 40 is compared to the size of the work included in the manufacturing planning work information 42 (step SD02). The information processing device 1 excludes the machine tool 2 from an object to be selected in a case where the size of the size is out of the machining range, and then starts making a comparison with the machine configuration information 40 of the next machine tool 2. In a case where the size of the work is within the machining range, the maximum machining work mass in the piece of machine configuration information 40 is further compared to the mass in the manufacturing planning work information 42 (step SD03). The information processing device 1 excludes the machine from the object to be selected in a case where the mass is out of the maximum machining work mass, and then starts making a comparison to the next piece of machine configuration information 40. In a case where the mass is within the maximum machining work mass, the information processing device 1 compares, for example, the drawings and material of the work included in the manufacturing planning work information 42 with the types of the tools in the tool information, so as to give a score to each set of the machine tool 2 and the tools in optimum order for the machining (step SD04). At this time, in a case where the machining achievement information 44 is present, a score is added to each set of the machine tool 2 and the tools (step SD05). After giving the scores to all the sets of the machine tool 2 and the tools, the information processing device 1 compares the scores given to the sets of the machine tool 2 and the tools so as to select a set of the machine tool 2 and the tool that has been given the highest score (step SB03).

In order to select a more optimum machine tool 2, the information processing device 1 makes the size of the work have an optimum width and makes a comparison with the machining range so that a score may be given in accordance with the machining range, in comparing the size of the work and the machining range.

The information processing device 1 displays the machine tool 2 that has been selected, onto a screen so as to issue a notification to the operator. Simultaneously, the information processing device 1 transmits drawing information 43 (e.g., a work type, a work shape, a finished shape, a tool type, a jig type, required accuracy, and surface roughness) acquired from the drawings of the work, to the machine tool 2 that has been selected (step SB04). The machine tool 2 receives the drawing information 43 transmitted from the information processing device 1 so as to save the drawing information 43 into a drawing information storage area.

The operator operates the machine tool 2 selected by the information processing device 1 and refers to the drawing information 43 stored in the drawing information storage area, so as to perform the machining in accordance with the drawing information 43 (step SB05). Here, in a case where the operator operates, for example, the MDI of the machine tool 2 and performs a setting different from that of the drawing information 43 stored in the drawing information storage area so as to perform the machining, the machine tool 2 adds, as change information, the setting changed by the operator to the drawing information 43 stored in the drawing information storage area.

When the machining is completed, the operator inputs an evaluation with respect to a machined result, through a machined result input screen of the machine tool 2. As information to be input at this time, a specific evaluation description with respect to the finish of the machining may be input, or more simply an evaluation may be given with a numerical value. As the machining achievement information 44, the evaluation information input in this manner, is saved in a machining information storage area. The machining achievement information 44 may include a result of the machining state of the work detected by, for example, a sensor, or may include a result in which the machining state of the work detected by, for example, the sensor has been compared with, for example, design dimensions included in the drawing information 43.

After that, the information processing device 1 collects a set of the drawing information 43 and the machining achievement information 44 from the machine tool 2 that has completed the machining (step SC01), and makes a registration into a machining achievement information database (step SC02).

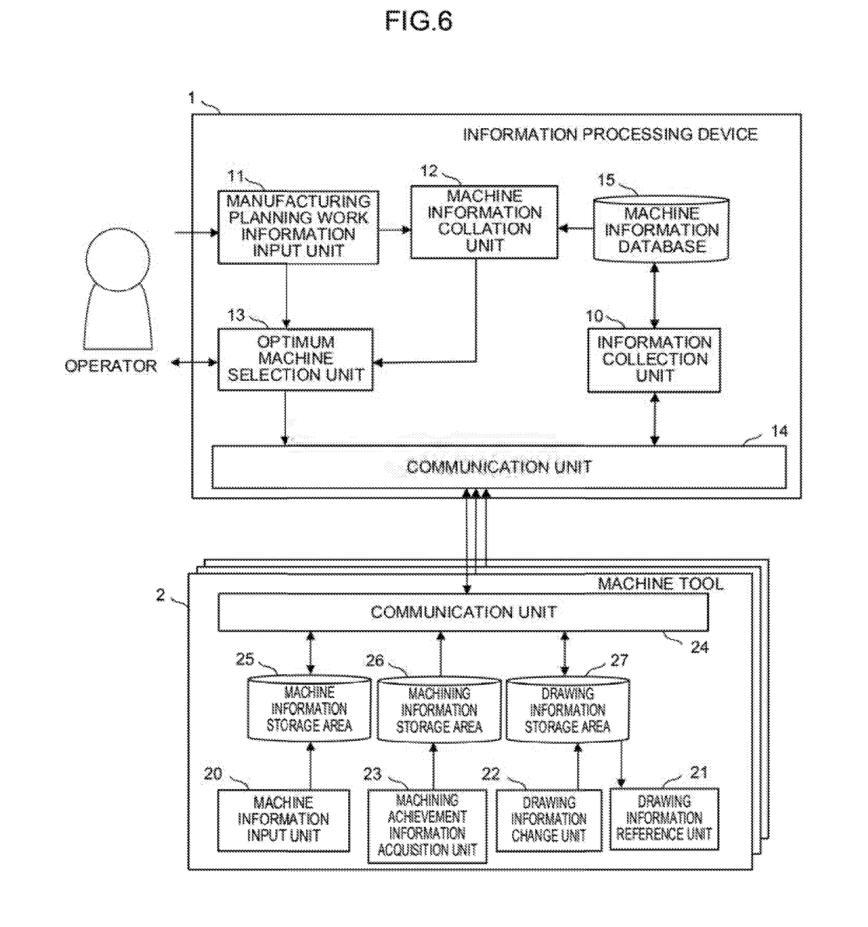

FIG. 6 is a schematic functional block diagram of the information processing device 1 and the machine tools 2 according to the embodiment of the present invention.

The information processing device 1 includes an information collection unit 10, a manufacturing planning work information input unit 11, a machine information collation unit 12, an optimum machine selection unit 13, a communication unit 14, and a machine information database 15. Each machine tool 2 includes a machine information input unit 20, a drawing information reference unit 21, a drawing information change unit 22, a machining achievement information acquisition unit 23, a communication unit 24, the machine information storage area 25, the machining information storage area 26, and the drawing information storage area 27. Note that, as omitted in FIG. 6, each machine tool 2 has a functional unit that performs machining of work.

The information collection unit 10 collects, through the communication unit 14, for example, the machine configuration information 40 and the tool information 41 stored in the machine information storage area 25, the drawing information 43 stored in the drawing information storage area 27, and the machining achievement information 44 stored in the machining information storage area 26, in each machine tool 2, so as to store the pieces of information into the machine information database 15 in association with each machine tool 2. The machine configuration information 40 and the tool information 41 have been input through the machine information input unit 20 in the maker or the factory. The drawing information 43 is transmitted from the information processing device 1 and is referenced by the drawing information reference unit 21 so as to be used for the machining by each machine tool 2. The drawing information 43 includes information changed by the operator with the drawing information change unit 22. The machining achievement information 44 includes information according to the evaluation of the work that has been machined, acquired by the machining achievement information acquisition unit 23 (e.g., the evaluation information input by the operator and information acquired by, for example, the sensor from the work after the machining).

The manufacturing planning work information input unit 11 receives the input of the manufacturing planning work information 42 by the operator. The manufacturing planning work information input unit 11 may receive, as the manufacturing planning work information 42, information input through an input device (e.g., a keyboard or a mouse), not illustrated, in the information processing device 1, information acquired from an external storage device with an instruction of the operator, or information acquired through a communication line.

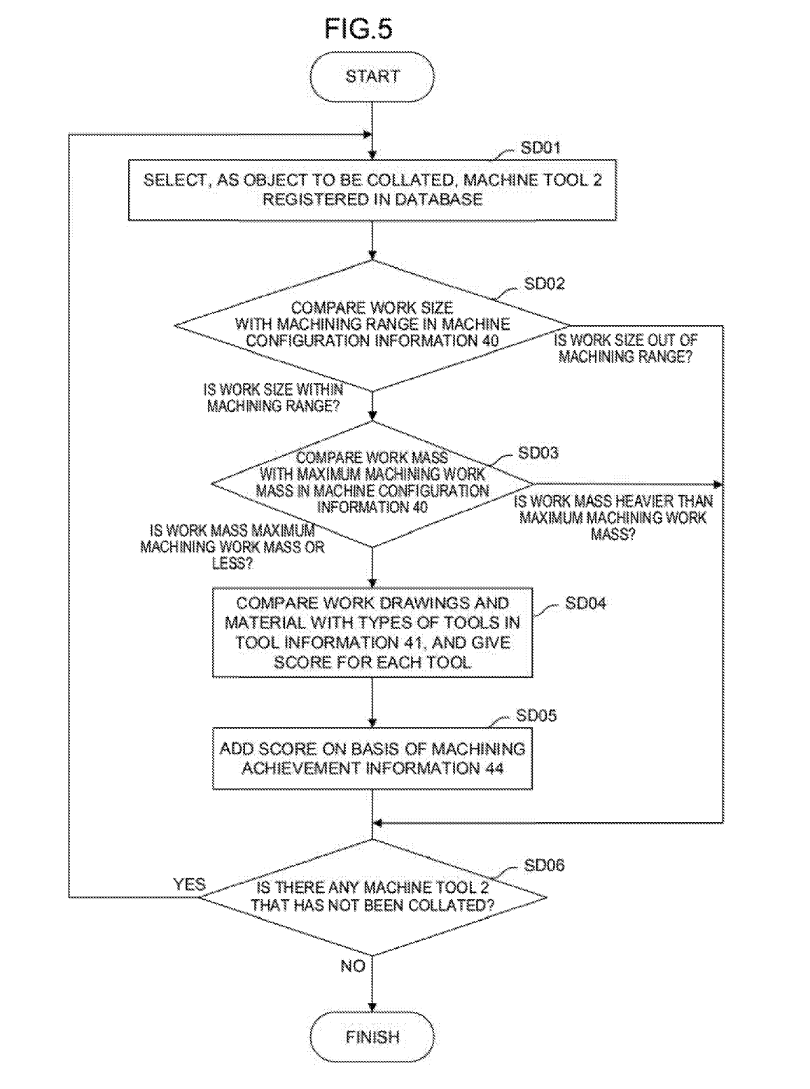

The machine information collation unit 12 collates the manufacturing planning work information 42 input from the manufacturing planning work information input unit 11 with the machine configuration information 40 and the tool information 41 of each machine tool 2 stored in the machine information database 15, so as to give a score to each machine tool 2 on the basis of a collated result. The machine information collation unit 12 gives a score to each machine tool 2, for example, in accordance with the flowchart illustrated in FIG. 5.

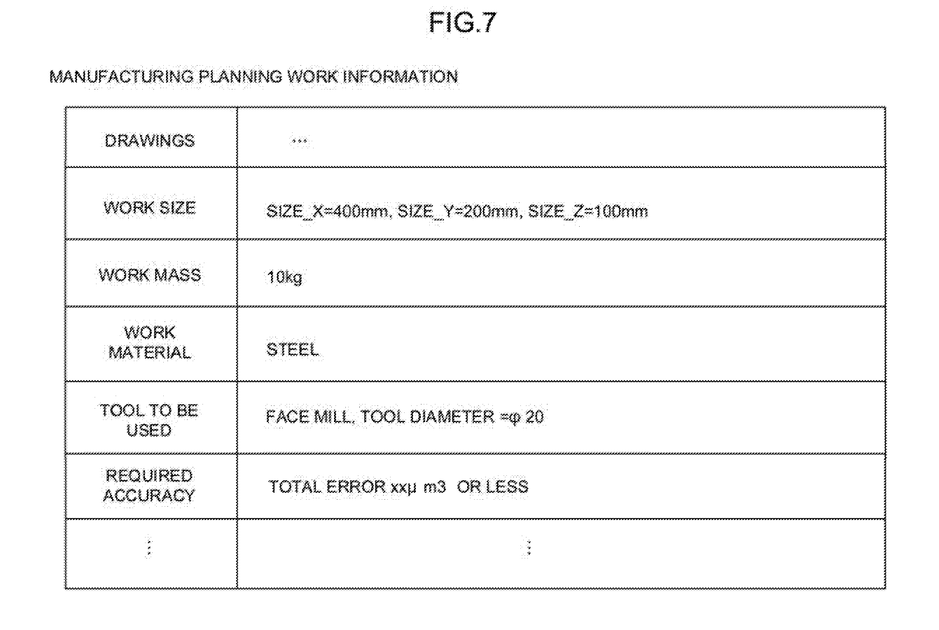

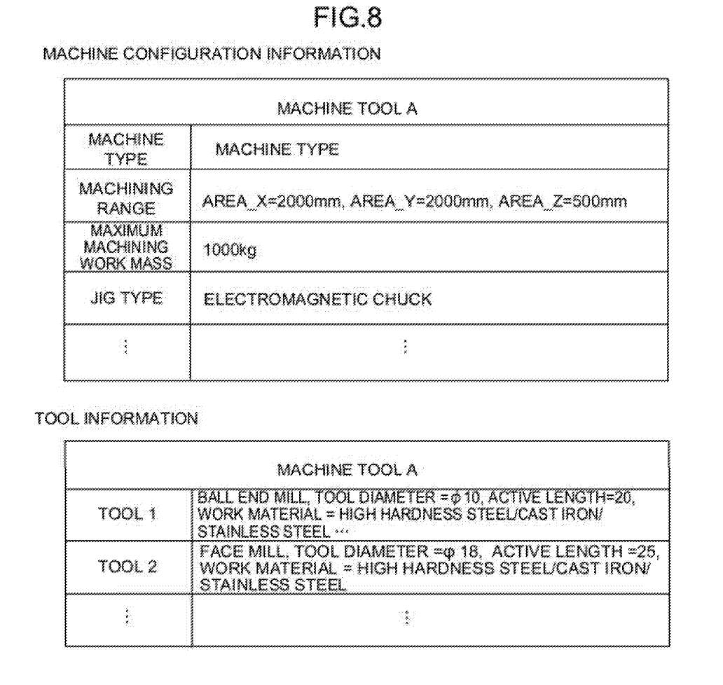

FIG. 7 is a table of exemplary manufacturing planning work information 42, and FIG. 8 illustrates tables of exemplary machine configuration information 40 and tool information 41. Such machine configuration information 40 and tool information 41 illustrated in FIG. 8 are associated with each of the plurality of machine tools 2 so as to be stored in the machine information database 15. As illustrated in the flowchart of FIG. 5, the machine information collation unit 12 compares the work size included in the manufacturing planning work information 42 and the machining range included in each piece of machine configuration information 40, so as to exclude a machine tool 2 having the machining range narrower than the work size, from an object to be given a score. Similarly, the machine information collation unit 12 compares the work mass included in the manufacturing planning work information 42 and the maximum machining work mass included in each piece of machine configuration information 40, so as to exclude a machine tool 2 having the maximum work mass smaller than the work mass, from the object to be given a score. After that, the machine information collation unit 12 collates each piece of information included in the manufacturing planning work information 42 with each piece of information included in each piece of machine configuration information 40 and each piece of information included in each piece of tool information 41. Then, in accordance with score-addition conditions based on a predetermined machine configuration, the machine information collation unit 12 individually performs score-addition to sets of each machine tool 2 and each tool included in each machine tool 2 so as to give scores. As the score-addition conditions based on the machine configuration, for example, a simple condition in which 10 points are added in a case where the type of a tool to be used specified with the manufacturing planning work information 42 agrees with the type of a tool in each piece of tool information 41, may be provided. Alternatively, a variable score-addition condition in which the differences (AREA_X−SIZE_X, AREA_Y−SIZE_Y, and AREA_Z−SIZE_Z) between the sides (AREA_X, AREA_Y, and AREA_Z) in the machining range in each piece of machine configuration information 40 and the sides (SIZE_X, SIZE_Y, and SIZE_Z) in the work size in the manufacturing planning work information 42, are calculated and then a larger score is given as each difference is closer to a predetermined threshold value a (>0), may be provided. For any of the score-addition conditions based on the machine configuration, in a case where the manufacturing planning work information 42 is collated with a piece of machine configuration information 40 and a piece of tool information 41, a higher score is required at least to be given when the machine tool 2 having the piece of machine configuration information 40 and the piece of tool information 41, is appropriate to the machining specified with the manufacturing planning work information 42. Alternatively, a minus score (score-subtraction) may be given when inappropriate to the machining specified with the manufacturing planning work information 42. Weighting may be performed between the score-addition conditions based on the machine configuration, to make the score-addition for an item emphasized in the machining higher than the score-addition for an item not necessarily important in the machining. Each score-addition condition based on the machine configuration may be experientially created on the basis of an opinion of a skilled operator.

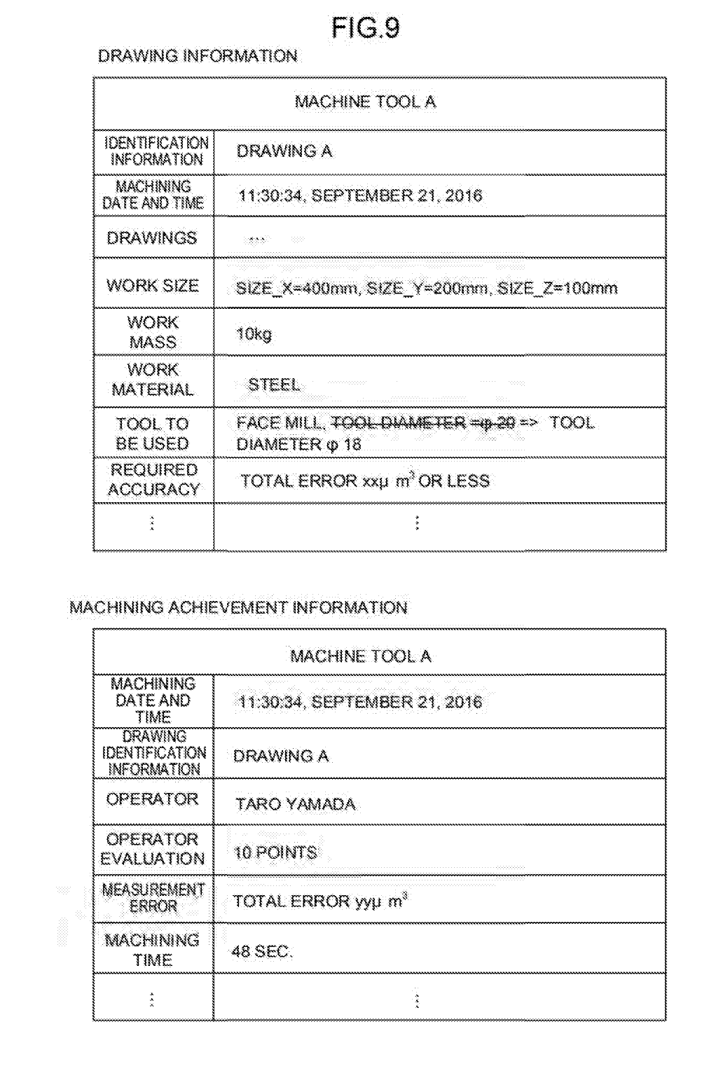

Furthermore, in a case where the drawing information 43 and the machining achievement information 44 have been stored in the machine information database 15, the machine information collation unit 12 may collate the manufacturing planning work information 42 input from the manufacturing planning work information input unit 11 with a set of the drawing information 43 and the machining achievement information 44 of each machine tool 2 (association can be performed with identification information, such as machining date and time or drawings, in the example of FIG. 9) stored in the machine information database 15. Then, the machine information collation unit 12 may further perform score-addition to each machine tool 2 on the basis of a collated result. FIG. 9 illustrates tables of exemplary drawing information 43 and machining achievement information 44. The machine information database 15 stores a set of such drawing information 43 and machining achievement information 44 illustrated in FIG. 9 in association with each of the plurality of machine tools 2. Note that the description of a tool diameter in a tool-to-be-used item of the drawing information 43 illustrated in FIG. 9, indicates that the tool diameter of the tool to be used has been specified with φ20 at an input stage of the manufacturing planning work information 42 but the operator has used the tool having a tool diameter of φ18 (changed) at a machining stage. As an exemplary method of score-addition based on the set of the drawing information 43 and the machining achievement information 44, the following is considered. The manufacturing planning work information 42 and each piece of drawing information 43 are compared so as to acquire similarity indicating how the two are similar. For the machining achievement information 44 set with a piece of drawing information 43 having similarity high to the manufacturing planning work information 42, a score to be given with score-addition conditions based on a predetermined machining achievement, is determined.

As a method of acquiring the similarity, for example, the following is required at least to be performed. The corresponding items between the manufacturing planning work information 42 and each piece of drawing information 43, are compared so as to acquire the similarity (0 to 1) of each item (e.g., for the drawings, similarity is acquired with shape matching, for the numerical values, more similarity is given as the numerical values are closer, and for the characters, exact agreement is given a similarity of 1 and disagreement is given a similarity of 0). The average value in which the similarity of each item that has been acquired, is weighted on the basis of the importance of each item, is calculated so that the comprehensive similarity is calculated. Then, in the machining achievement information 44 set with a piece of drawing information 43 having the similarity higher than a predetermined threshold value that has been previously determined (e.g., 0.8 or more), the score of operator evaluation remaining intact may be given or the score weighted in response to the similarity may be given. Alternatively, in a case where a measurement error is smaller than a predetermined threshold value (e.g., the required accuracy included in the drawing information 43 in the set), score—addition may be performed in response to the smallness, and when exceeding the predetermined threshold value, score-subtraction may be performed in response to the excess. Furthermore, as machining time is shorter than a predetermined reference value, score-addition may be performed in response to the shortness and as longer than the predetermined threshold value, score-subtraction may be performed in response to the long. For the score-addition conditions based on the machining achievement, a high score is required at least to be given in a case where a desirable machined result is acquired, and a minus score is required at least to be given (score-subtraction) in a case where an inappropriate machined result is acquired. Weighting may be performed between the score-addition conditions based on the machining achievement, to make the score-addition for the item emphasized in the machining higher than the score-addition for the item not necessarily important in the machining. Each score-addition condition based on the machining achievement may be experientially created on the basis of an opinion of the skilled operator.

The optimum machine selection unit 13 includes a functional unit that selects a machine tool 2 appropriate to the machining specified with the manufacturing planning work information 42, on the basis of the score given to each machine tool 2 by the machine information collation unit 12. The optimum machine selection unit 13 may present a machine tool 2 given the highest score, to the operator and may select the machine tool 2 as an optimum machine tool 2 for the machining. The optimum machine selection unit 13 may display a list of a predetermined number of machine tools 2 in high score order, to the operator, may make the operator select a machine tool 2 to be used for the machining from the machine tools 2, and may select the machine tool 2 that has been selected, as the optimum machine tool 2 for the machining. After selecting the machine tool 2 as being optimum for the machining, the optimum machine selection unit 13 transmits the drawing information 43 created on the basis of the manufacturing planning work information 42 input from the manufacturing planning work information input unit 11, to the machine tool 2 that has been selected, through the communication unit 14.

Then, the operator can perform the machining on the basis of the drawing information 43 that has been transmitted, with the machine tool 2 selected by the optimum machine selection unit 13. Before performing the machining, the operator operates, for example, the MDI of the machine tool 2 to read and refer to the drawing information 43 (the drawing information reference unit 21) and, as necessary, changes, for example, a tool or a machining condition to perform the machining. The drawing information change unit 22 collects an item changed in the machining so as to add the item, as change information to the drawing information 43, to the drawing information 43. When the machining is completed, the machining achievement information acquisition unit 23 stores, as the machining achievement information 44, the evaluation information input by the operator or the information acquired from the work that has been machined, with, for example, the sensor, into the machining information storage area 26. The information collection unit 10 collects the pieces of information, into the information processing device 1.

The embodiment of the present invention has been described above, but the present invention is not limited to only the examples of the embodiment described above, and thus the present invention may be achieved in various modes with addition of appropriate alterations.

For example, each item included in each piece of information, such as the machine configuration information 40, the tool information 41, the manufacturing planning work information 42, the drawing information 43, and the machining achievement information 44, is just exemplary and thus an item indicating different information may be included.

1. An information processing device configured to select an optimum machine tool for machining from a plurality of machine tools, the information processing device comprising:
a machine information database configured to store, for each of the plurality of machine tools, machine configuration information indicating a machine configuration of each of the plurality of machine tools and tool information including information according to a tool included in each of the plurality of machine tools, in association with each of the plurality of machine tools;
an information collection unit configured to collect the machine configuration information and the tool information from each of the plurality of machine tools so as to store the machine configuration information and the tool information into the machine information database;
a manufacturing planning work information input unit configured to receive manufacturing planning work information specifying information according to the machining;
a machine information collation unit configured to collate the manufacturing planning work information received by the manufacturing planning work information input unit with the machine configuration information and the tool information stored in the machine information database so as to give a score to each of the plurality of machine tools associated with the machine configuration information and the tool information, based on the result of the collation; and
an optimum machine selection unit configured to select the optimum machine tool for the machining specified with the manufacturing planning work information, based on the score given to each of the plurality of machine tools by the machine information collation unit.

2. The information processing device according to claim 1, wherein the machine information database further stores, for each of the plurality of machine tools, drawing information including information according to a description of the machining performed by each of the plurality of machine tools and machining achievement information including information according to an evaluation of a result of the machining, in association with each of the plurality of machine tools, and
the machine information collation unit collates the manufacturing planning work information received by the manufacturing planning work information input unit with the drawing information and the machining achievement information stored in the machine information database, so as to perform score-addition to the score, based on the result of the collation.
